(19) United States
(12) Patent Application Publication
(10) Pub. No.: US 2009/0112394 A1
(43) Pub. Date: Apr. 30, 2009

(54) APPARATUS FOR COLLECTING, STORING AND TRANSMITTING VEHICLE INFORMATION

(75) Inventors: Yervant David Lepejian, Glendale, CA (US); Gurgen Levoni Lachinyan, Palo Alto, CA (US)

Correspondence Address: MYERS WOLIN, LLC, 100 HEADQUARTERS PLAZA, North Tower, 6th Floor, MORRISTOWN, NJ, 07960-6834, US

(73) Assignee: SOSY TECHNOLOGIES STU, INC., Santa Clara, CA (US)

(21) Appl. No.: 12/261,348

(22) Filed: Oct. 30, 2008

Related U.S. Application Data
(60) Provisional application No. 61/000,865, filed on Oct. 30, 2007.

(51) Int. Cl. G01M 17/00

(52) U.S. Cl. 701/30; 701/33

(57) ABSTRACT

An apparatus for collecting, storing and transmitting vehicle information. The apparatus comprises an on-board diagnostic (OBD) port interface for providing connection to an OBD port of a vehicle; a plurality of engine sensory monitors for collecting at least engine status and diagnostic information; a plurality of non-engine sensory monitors for collecting at least non-engine status and diagnostic information; a processor for processing at least information collected by the plurality of engine sensory monitors and the plurality of non-engine sensory monitors; and a plurality of communication interfaces for interfacing with a service system for the purpose of transmitting the processed information to the external service system.

### CROSS-REFERENCE TO RELATED-APPLICATIONS

This application claims the benefit of U.S. Provisional Application No. 61/000,865 filed on Oct. 30, 2007, the contents of which are herein incorporated by reference.

### FIELD OF THE INVENTION

The present invention generally relates to collecting, analyzing and transmitting data from an automobile.

### BACKGROUND

Today there is a need for vehicle performance monitoring, tracking, preventive repair and service support. This need is filled in some high-end vehicles by the addition of circuits like, for example, an OnStar® circuit available in General Motors® vehicles, which is integrated into the vehicle during manufacturing. Typically, this circuit is a capability that is enabled during a need by the user. There are also vehicle tracking and disabling capabilities similar to Lojack®.

Today there are no devices or systems that can be used as a standard add-on device to allow the monitoring and controlling of the vehicle systems. In addition, there are no devices or systems that provide the capability of monitoring the user profile of a vehicle and provide the driver with necessary information to enable efficient use of available information for preventive maintenance to be done during the operation of the vehicle.

It would be therefore advantageous to provide a device and support system as a standard that can be part of the manufactured vehicle or added as an after-market sale to enable effective use of available data.

### SUMMARY

Certain embodiments of the invention include an apparatus for collecting, storing and transmitting vehicle information. The apparatus comprises an on-board diagnostic (OBD) port interface for providing connection to an OBD port of a vehicle; a plurality of engine sensory monitors for collecting at least engine status and diagnostic information; a plurality of non-engine sensory monitors for collecting at least non-engine status and diagnostic information; a processor for processing at least information collected by the plurality of engine sensory monitors and the plurality of non-engine sensory monitors; and a plurality of communication interfaces for interfacing with a service system for the purpose of transmitting the processed information to the external service system.

Certain embodiments of the invention further include a service system. The service system comprises a network service interface for interfacing with a vehicle monitoring apparatus, wherein the vehicle monitoring apparatus continuously delivers at least vehicle's monitoring information to the service system; a business logic to determine at least a type of service that can be provided to the vehicle; a handheld personal communicator for providing updates, status and maintenance warnings based on the continuous monitoring information; at least one internal site operation for handling an on-site service; and at least one mobile application for providing information about the status of the vehicle based on the vehicle's monitoring information.

### BRIEF DESCRIPTION OF THE DRAWINGS

FIG. 1 is a block diagram of an apparatus for collecting, storing and transmitting vehicle information constructed in accordance with an embodiment of the invention.

FIG. 2 is a block diagram of the service system constructed in accordance with an embodiment of the invention.

### DETAILED DESCRIPTION OF THE PREFERRED EMBODIMENTS

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

One embodiment of an apparatus for collecting and delivering, by multiple means, information regarding engine status and diagnostics, location with directional information, information regarding the driver, and other non-engine car data is shown. The apparatus is powered through an on-board diagnostic (OBD) port, for the purpose of collecting and delivering the necessary data. A service system, also disclosed, is used for receiving and processing the information.

One embodiment of the apparatus comprises an OBD interface, a battery monitor, a tire monitor, a Bluetooth® transceiver, a global positioning system (GPS) receiver with built-in antenna, a frequency modulation (FM) broadcast transmitter also with built in antenna, a global system for mobile communication (GSM) radio transceiver, necessary Flash and dynamic random access memory (DRAM), an analog-to-digital (A/D) block and a processor for data processing. It is made available as a tool for continuous monitoring of the performance and evaluation of the operation of a vehicle typically as an aftermarket addition to the vehicles. A disconnect indication and protection Battery (DPB) is also part of the apparatus to enable disconnection information transfer if the device is disconnected from the OBD once the apparatus is connected and configured.

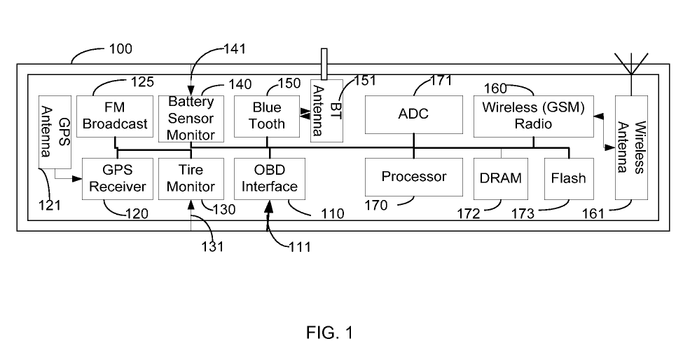

FIG. 1 shows an exemplary and non-limiting block diagram of an apparatus 100 implemented in accordance with an embodiment of the invention. Today all automotive vehicles have an OBD port that is connected to the internal bus of the vehicle. The OBD port has access to all the sensory data that is continuously generated and fed to the processors of the vehicle, thereby enabling optimization of performance and surveillance of the conditions of operation. The OBD port is also available to the service technician for analysis of the performance of the vehicle and debug during repair. Power and all the sensory and operational data are made available at the OBD port. This enables the apparatus 100 to easily connect to the OBD port through a built-in OBD interface 111 and access this data stream and power. All the information regarding the engine and vehicle operation are also available through the OBD interface 111. This information is input to the apparatus 100 through the interface connector.

The apparatus 100 further comprises a GPS receiver 120, with a built-in GPS antenna 121, to determine the location of the vehicle, a tire monitoring unit 130 that receives an input 131 from sensors in the tires of the vehicle to monitor at least the tire pressure and temperature, a battery sensor monitoring circuit 140 to continuously monitor the battery performance and conditions through the battery connection 141, and a Bluetooth® transceiver 150 with an antenna 151, to communicate information and status directly with, for example, cell phones of the operator of the vehicle. This also allows apparatus 100 to profile the operator and enables possible limiting conditions to be imposed on the operation of the vehicle if so desired.

The apparatus 100 further comprises a FM broadcast transmitter 125 that connects to the vehicle's radio for hands-free voice and status communication during vehicle operation. The apparatus 100 further provides for connectivity to an external wireless network through a radio transceiver 160 with an integrated antenna 161. The external wireless connectivity is used to monitor the condition of the vehicle, the location of the vehicle, its operational status and the profile of the operator on a semi-continuous basis and provides the vehicle owner with necessary service warnings through short message service (SMS), email or cell phone gateways as and when detected. The sensory inputs and the communication inputs and outputs are processed by the apparatus 100 using a processor 170, typically, but not by way of limitation, an ARM® processor and analog-to-digital converter (ADC) circuits 171. The sensory and communication inputs are stored in a DRAM 172 during processing and then in a non-volatile memory such as a Flash memory 173 for future read back and analysis, prior to being sent out to the external wireless net.

Even though the apparatus 100 is shown as comprising a set of typical components, it should not be viewed as a limitation on adding to or removing from apparatus 100 individual components to enable or disable specific applications as the needs arise. An apparatus providing the teachings of the invention whether having all the subsystems described hereinabove, any additional component, or a portion thereof, and which do not depart from the spirit of the disclosed invention, are specifically included as part of this invention. In a preferred embodiment of the invention, the apparatus 100 is constructed as a monolithic integrated chip (IC).

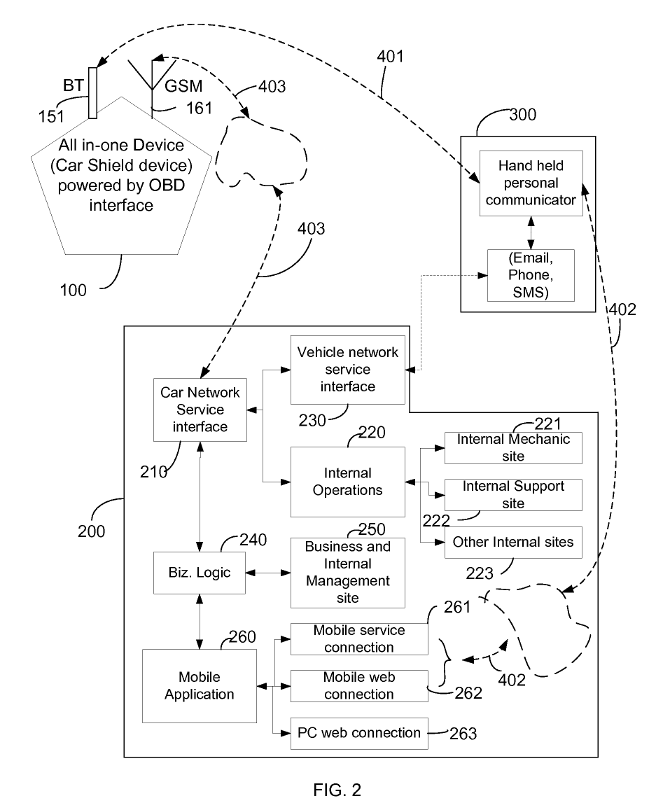

FIG. 2 shows an exemplary and non-limiting block diagram of a service system 200 operative in accordance with certain embodiments of the invention. The service system 200 receives information gathered by the apparatus 100 and performs a plurality of service applications, some of which are described in detail below. In accordance with one embodiment a mobile handheld personal communicator 300 may be utilized for exchanging information between the apparatus 100 and the service system 200.

The apparatus 100 is connected to the OBD port of a vehicle for accessing power from the vehicle's batteries. The apparatus 100 has access to all the information regarding the operation and status of the vehicle systems directly from the internal bus of the vehicle, the position and direction of the vehicle from the built-in GPS 120, the battery status and operational information from the built-in battery sensor monitor 140 as well as the tire temperature and pressure status from the built-in monitor 130 that accesses the sensors in the tires of the vehicle.

The apparatus 100 is expected to be continuously monitoring, processing and saving information regarding the vehicle performance and operation. If the apparatus 100 is disconnected from the OBD once it has been connected and configured, the apparatus 100 is expected to provide intimation of this event. This is performed by having a disconnect indication and protection Battery (DPB) (not shown) to supply the necessary power after disconnection. When the apparatus 100 is disconnected the battery power from the DPB is used to provide information and continue monitoring and storage application for a defined period of time.

The apparatus 100 has multiple levels of connectivity. For example, the apparatus 100 can connect directly to the mobile handheld personal communicator 300, similar to a cell phone, and provide updates, status and maintenance warnings through a Bluetooth® link 401. The apparatus 100 can also connect to the internal radio of a vehicle enabling a hands free mode through the built-in FM broadcast transmitter 125.

Another connection of the service system 200 is to a car network service interface 210 through a wireless link 403 using the wireless transceiver 160 of the apparatus 100. The information presented can be used in multiple ways to provide services after verifying the business and internal management clearances through a business logic 240 using the business and management database at a business and internal management site 250.

An example for a service application, disclosed in accordance with one embodiment of the invention, is the use of the continuous monitoring capability of the apparatus 100, to provide updates, status and maintenance warnings to an operator including possible need for preventive maintenance and repairs before a breakdown occurs. This can be done by wireless means through a short text message, a phone message, an email message, and the like, whichever is available as a preferred wireless connection to the handheld personal communicator 300 of the operator of the vehicle. This facility can be established and offered as part of a service through the service system 200 by connecting to a vehicle through a vehicle network service interface 230.

Another example for a service application, disclosed in accordance with an embodiment of the invention, is the ability to provide on-site service. This includes providing access to service facilities, towing, access to service mechanics, opening of locked doors, providing warning of low fuel and support for tire and battery problems, and so on. These services can be provided both in emergency and non-emergency situations as the continuous monitoring facility provides the capability to have early warning of problems with the vehicle. The capability can be provided as part of the business system which uses the connectivity 403 to monitor and provide advanced warning of need for service and repair through internal operations 220 which has the right facilities for handling the needed services through an internal mechanic site 221, an internal support site 222, and other internal operations site 223.

As another example for a service application, disclosed in accordance with an embodiment of the invention, is providing information about the status of the vehicle to the owner or operator through a personal computer (PC) web connection 263, a mobile web connection 262, or a mobile phone connection 261 regarding the current operation and status using the connectivity to the mobile applications 260 within the service system 200. This can include using the profile of the current user and defining the limitations to be set including reduced maximum speed setting in case of under-aged drivers, or the disabling of the engine to prevent theft of the vehicle in the case of unknown drivers. Since direct connectivity to the vehicle through the apparatus is available at all times and Bluetooth® base profiling of possible users are also available in the stored information on system this can be efficiently implemented. The system is made aware of the user of the vehicle and his or her profile is correlated to the profile and instructions available in the system database to send back instructions to the vehicle through the apparatus and the OBD port to enable the controls and limitations. It is also possible to locate any vehicle with the GPS capability and inform the owner or the authorities.

The mobile applications 260 also enable the service system 200 to enroll users into the system and capture the needed information to authenticate and verify the user inclusion in the system operations prior to providing the necessary service.

The use of the apparatus 100 hence enables the tracking, maintaining and safe operation of the vehicle using the continuous monitoring and reporting facility built into the apparatus 100. This facility can be used by the service system 200 to enable a number of necessary services. Though a few of the services have been defined for a typical system 200, it should not be construed that these are the only components or applications possible. Many related and unrelated business opportunities should be apparent to one of ordinary skill in the art when the apparatus 100 is in use and are specifically included herein as part of the disclosed invention.

It should be apparent to one of ordinary skill in the art that the service applications as well as some or all of the components of the apparatus 100 and service system 200 described herein can be implemented in hardware, software, firmware, or any combination thereof. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

We claim:

1. An apparatus comprising:
an on-board diagnostic (OBD) port interface for providing connection to an OBD port of a vehicle;
a plurality of engine sensory monitors for collecting at least engine status and diagnostic information;
a plurality of non-engine sensory monitors for collecting at least non-engine status and diagnostic information;
a processor for processing at least statuses and information collected by the plurality of engine sensory monitors and the plurality of non-engine sensory monitors; and
a plurality of communication interfaces for interfacing with an external service system for transmitting the processed statuses and information to the external service system.

2. The apparatus of claim 1, further comprising:
a global positioning system (GPS) receiver with a built in antenna for determining location information of the vehicle;
a volatile memory for storing statuses and information collected by the plurality of engine sensory monitors and the plurality of non-engine sensory monitors; and
a non-volatile memory for storing location information and processed information.

3. The apparatus of claim 2, wherein the non-volatile memory includes information regarding a driver of the vehicle.

4. The apparatus of claim 1, wherein the processor processes digital signals provided by a digital-to-analog converter.

5. The apparatus of claim 1, wherein the plurality of non-engine sensory monitors comprise at least one of: a battery sensory monitor and a tire sensory monitor.

6. The apparatus of claim 1, wherein the OBD port powers the apparatus.

7. The apparatus of claim 1, wherein the plurality of communication interfaces comprise at least one of: a Bluetooth® transceiver, a FM broadcast module, and a wireless radio.

8. The apparatus of claim 1, wherein the processed information transmitted to the service system includes at least engine status and diagnostic information, non-engine's vehicle information, location and directions information, and information regarding the driver.

9. A service system comprising:
a network service interface for interfacing with a vehicle monitoring apparatus, wherein the vehicle monitoring apparatus continuously delivers at least vehicle's monitoring information to the service system;
a business logic to determine at least a type of service that can be provided to the vehicle;
a handheld personal communicator for providing updates, status and maintenance warnings based on the continuous monitoring information;
at least one internal site operation for handling an on-site service; and
at least one mobile application for providing information about a status of the vehicle based on the vehicle's monitoring information.

10. The service system of claim 9, wherein the continuous monitoring information includes at least engine status and diagnostic information, non-engine's vehicle information, location and directions information, and information regarding a driver of the vehicle.

11. The service system of claim 9, wherein the handheld personal communicator provides the updates by means of at least one of: a short text message, a phone message, and an email message.

12. The service system of claim 9, wherein the on-site service comprises at least one of: an access to service facilities, a towing service, an access to service mechanics, opening of locked doors, providing warnings of low fuel, and supporting tire and battery problems.

13. The service system of claim 12, wherein the internal site operation includes at least one of: an internal mechanic site and an internal support site.

14. The service system of claim 9, wherein the mobile application includes at least one of: a personal computer web connection, a mobile web connection, and a mobile phone connection.

15. An apparatus for collecting, storing and transmitting vehicle information comprising:
means for connecting to an internal bus of a vehicle for collecting, processing and storing of engine status and engine diagnostic information available from the internal bus;
means for generating, processing and storing location and directional information of the vehicle and storing as collected data;
means for generating processing and storing information regarding a driver of the vehicle and storing as collected data;
means for collecting non-engine vehicle information for processing and storing as collected data; and
means for transmitting said collected data to a service system,
wherein the collected data is available for use by the service system for at least monitoring the condition and performance of the vehicle in order to provide service inputs, service support and security of the vehicle.

16. A service system for monitoring condition and performance of a vehicle in order to provide service inputs, service support and security to the vehicle, utilizing outputs of an apparatus connected by means of an on board diagnostic (OBD) interface to an OBD port of a vehicle and powered through the OBD port of the vehicle, the apparatus enabled for collecting, processing and delivering, by multiple communication means, information regarding engine status, engine diagnostics, location of the vehicle with directional information, information regarding a driver, and non-engine vehicle information, in order to provide a necessary inputs to enable the operation of the service system.
